(19) United States
(12) Patent Application Publication
(10) Pub. No.: US 2009/0046705 A1
(43) Pub. Date: Feb. 19, 2009

(54) Method and System for Facilitating Establishment of an Ip-Link in a Telecommunications System

(76) Inventor: Rogier August Caspar Joseph Noldus, Goirle (NL)

Correspondence Address: ERICSSON INC., 6300 LEGACY DRIVE, M/S EVR 1-C-11, PLANO, TX, 75024, US

(21) Appl. No.: 12/158,916

(22) PCT Filed: Dec. 27, 2005
(86) PCT No.: PCT/EP2005/014071

§ 371 Date: Sep. 4, 2008

(51) Int. Cl. H04L 12/66

(52) U.S. Cl. 370/352

(57) ABSTRACT

A mobile switching center (MSC) 5 is arranged to set up a call with a destination subscriber unit 13 via a public switched telephone network (PSTN) 15. An IP-based communication link between the service control point (SCP) 9 and the destination subscriber unit 13 is established. During a call set-up procedure between the calling subscriber and the destination subscriber unit 13, the IP address of the required service (i.e. of the relevant service control point 9) is transmitted to the destination subscriber unit 13 via the MSC 5 by means of a circuit switched protocol. Alternatively the IP address of the destination subscriber unit 13 is transmitted to the mobile switching center (MSC) 5 in a signaling message relating to a connect procedure, towards the SCP 9 of the calling party.

### FIELD OF THE INVENTION

The invention relates to a telecommunications system and method, and in particular to a telecommunications system and method having enhanced user addressing to facilitate IP-based communication.

### BACKGROUND OF THE INVENTION

FIG. 1 shows a typical telecommunications system in which a mobile station MS communicates with a mobile switching center MSC over an air interface. The mobile switching center MSC is connected to a service control point SCP. Although FIG. 1 shows a fixed connection between the mobile switching center MSC and the service control point SCP, this connection can be wireless or via a communication network, as the case may be. The mobile switching center MSC is arranged to set up a call with a destination subscriber unit EXT via a public switched telecommunications network PSTN. The destination subscriber unit EXT may be a single terminal or a private automatic branch exchange (PABX) with a number of extension terminals connected to it.

It is often required that the service control point SCP communicates with the destination subscriber unit EXT during a call. One example is during Customized Applications for Mobile Network Enhanced Logic (CAMEL) operations, for example when setting up an emergency call between a mobile station and an emergency center.

In such an application, a CAMEL/CS1+ service that is invoked for the emergency call may have the need to send call related data to the emergency center (i.e. the destination subscriber unit EXT). In such a situation, the service control point SCP needs to receive the address of the emergency centre in the answer notification. This address has the format of an E.164 number.

While such a system is suitable for setting up standard telephone communication between the mobile station and the destination subscriber, the system is not suited for setting up IP-based communication between the SCP and the destination subscriber unit EXT. Setting up IP-based communication between the SCP and the destination subscriber unit EXT is required, for example, when the destination subscriber unit EXT is a Circuit Switched (CS) terminal with an IP interface.

The aim of the invention is to provide a telecommunications system and method that enables IP-based communication to be performed between a service control point SCP and a destination subscriber unit EXT.

### SUMMARY OF THE INVENTION

According to a first aspect of the invention, there is provided a method of establishing an IP-based communication link between a service control point of a calling subscriber and a destination subscriber unit. The method comprises the steps of communicating an IP address transferred by means of a circuit switched protocol via a circuit switched network communicatively connected to the service control point and the destination subscriber unit, and establishing the IP based communication link between the service control point and the destination subscriber unit based on the communicated IP address between the service control point and the destination subscriber unit.

The communication of the IP address using the circuit switched protocol and the circuit switched network in this manner enables the service control point and the destination subscriber unit to establish a direct IP-based communication link that can be used, for example, to enhance the establishment of an emergency call. The exchange of IP addresses between SCP and destination subscriber unit may be used by the SCP to provide additional call related and user related information to the emergency centre. Another example is the case whereby a user calls an automobile help service. The SCP can use the exchange of IP addresses to provide information such as Location Information to the assisting agent. A third example is the case whereby the SCP uses the exchange of IP addresses to send a menu to the terminal of a called party, to request the consent of the called party for an action such as charge reversal.

According to another aspect of the invention, there is provided a telecommunications system for establishing an IP-based communication link between a service control point of a calling subscriber and a destination subscriber unit. The telecommunications system comprises a circuit switched network for communicating an IP address transferred by means of a circuit switched protocol via the circuit switched network communicatively connected to the service control point and the destination subscriber unit, and means for establishing the IP based communication link between the service control point and the destination subscriber unit based on the communicated IP address between the service control point and the destination subscriber unit.

According to another aspect of the invention, there is provided a service control point adapted to perform the method defined in the appended claims.

According to another aspect of the invention, there is provided a destination subscriber unit adapted to perform the method defined in the appended claims.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a telecommunications system configuration where the invention is applicable;

FIG. 2 shows the telecommunications system with applied protocols according to the present invention;

FIG. 3 shows a flow chart illustrating the steps involved in setting up an IP-based communication between the SCP and the destination subscriber unit; and

FIG. 4 shows an overview of call setup in the telecommunications system according to the present invention,

### DETAILED DESCRIPTION OF A PREFERRED EMBODIMENT OF THE INVENTION

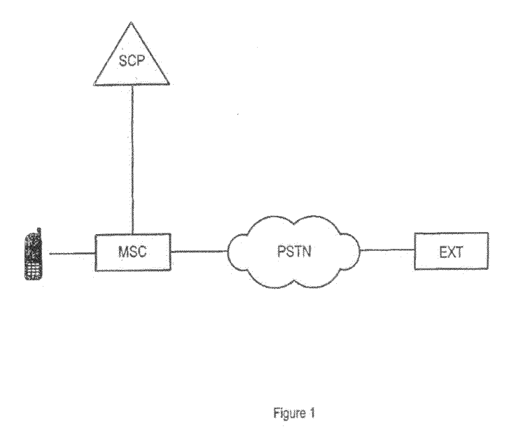

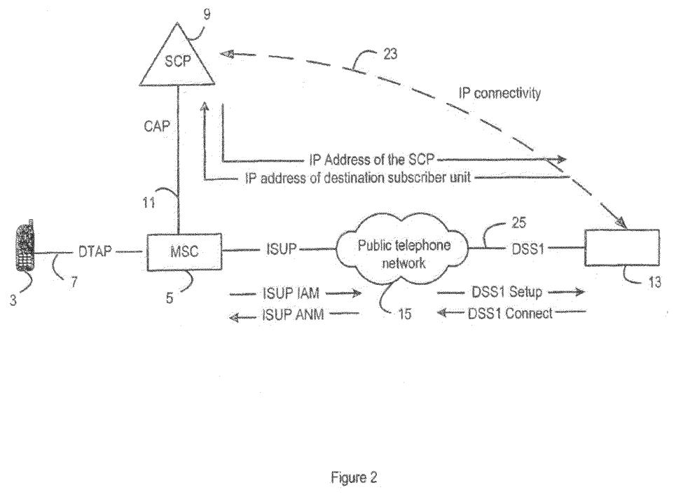

FIG. 2 shows a telecommunications system according to the present invention. In a similar manner to FIG. 1, a mobile station 3 is connected to a mobile switching centre (MSC) 5 over an air interface 7. The mobile switching centre (MSC) 5 is connected to a service control point (SCP) 9. The mobile switching center (MSC) 5 is arranged to set up a call with a destination subscriber unit 13 via a public switched telecommunications network (PSTN) 15. It will be appreciated that the destination subscriber unit 13 may be a single terminal or a private automatic branch exchange (PABX) with a number of extension terminals connected to it.

According to the invention, an IP-based communication link between the service control point (SCP) 9 and the destination subscriber unit 13 is established as follows. During a call setup procedure between the calling subscriber (mobile station 3) and the destination subscriber unit 13, the IP address of the required service (i.e. of the relevant service control point (SCP) 9) is transmitted to the destination subscriber unit 13. In response to receiving the IP address of the required service, the IP address of the destination subscriber unit 13 is returned to the mobile switching center (MSC) 5 in a backward signaling message towards the calling subscriber 3. This exchange of IP addresses between the service control point (SCP) 9 and the destination subscriber unit 13 facilitates IP based communication to take place directly between the service control point (SCP) 9 and the destination subscriber unit 13.

It is noted that the IP address of the service control point (SCP) 9 may relate to the service control point (SCP) 9 as a whole, or may relate to a process instance in the service control point (SCP) 9. It is also noted that, although the preferred embodiment discusses the IP addresses of both the service control point (SCP) 9 and that of the destination subscriber unit 13 being exchanged, it will be appreciated that the invention is equally applicable to just one of the addresses being exchanged, for example when communication is to be initiated by just one of the parties.

A more detailed description of how the IP addresses are exchanged will now be given.

When a calling subscriber 3 establishes an outgoing call, a CAMEL service may gain control over the call. The CAMEL service has the capability to influence the call flow and provides the information elements which are required to be placed in the Integrated Services Digital Network (ISDN) User Part, known as ISUP, information flow towards the local exchange in the public switched telecommunications network (PSTN) 15.

By using an operation command from the CAMEL application part (CAP) between the mobile switching center (MSC) 5 and service control point (SCP) 9, the service control point (SCP) 9 is adapted to place or modify elements in the ISUP Initial Address Message (IAM). The ISUP IAM is a message that is sent from an originating exchange, such as an MSC, to a destination exchange during a call setup procedure.

In particular, the service control point (SCP) 9 is adapted to place or modify the following elements in the ISUP Initial Address Message (IAM):
Additional Calling Party number;
Calling Party Category.

The additional calling party number is an information element that is conveyed as a “Generic Numbe” (GN). The Generic Number (GN) is a generic transport mechanism in ISUP for the transportation of a number, for various purposes, as defined in ITU-T Recommendation Q.763.

The format of the Generic Number (GN) is shown below in Table 1, which shows the format and encoding of a Generic Number (GN) according to the ITU-T recommendation Q.763.

TABLE 1

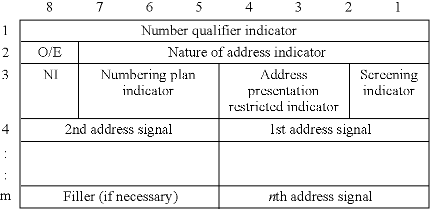

Number qualifier indicator

| | |
|---|---|
| 0 0 0 0 0 0 0 0 | reserved (dialled digits) (national use) |
| 0 0 0 0 0 0 0 1 | additional called number (national use) |
| 0 0 0 0 0 0 1 0 | reserved (supplemental user provided calling number - |
| | failed network screening) (national use) |
| 0 0 0 0 0 0 1 1 | reserved (supplemental user provided calling number - |
| | not screened) (national use) |
| 0 0 0 0 0 1 0 0 | reserved (redirecting terminating number) (national use) |
| 0 0 0 0 0 1 0 1 | additional connected number |
| 0 0 0 0 0 1 1 0 | additional calling party number |
| 0 0 0 0 0 1 1 1 | reserved for additional original called number |
| 0 0 0 0 1 0 0 0 | reserved for additional redirecting number |
| 0 0 0 0 1 0 0 1 | reserved for additional redirection number |
| 0 0 0 0 1 0 1 0 | reserved (used in 1992 version) |

$\begin{matrix}00001011 \\ to \\ 01111111\end{matrix} \} spare \\ \begin{matrix}10000000 \\ to \\ 11111110\end{matrix} \} reserved for national use$ $1 \; 1 \; 1 \; 1 \; 1 \; 1 \; 1 \; 1 reserved for expansion$

As can be seen, the definition of the Generic Number contains GN types that are meant for national use only. That means that within the boundaries of a country, entities that communicate with one another over the public switched telecommunications network PSTN or PLMN may exchange GN values with a nationally reserved value.

According to the invention, the following identifiers are used to facilitate IP-based communication:
IP Address of the SCP 9; and
IP address of the destination subscriber unit 13

The identifiers are transferred as Generic Numbers (GN) types and are used in the following manner. When a CAMEL service establishes control of a call, the CAMEL service includes the generic number GN[1000,000] (“GN128”), for example, in the “CAP Connect” (known as CAP-CON) operational command or in the “CAP Continue with Argument” (known as CAP-CWA) operational command. The GSM service switching function (gsmSSF) includes this Generic Number (GN) type in the initial address message (ISUP IAM) towards the local exchange in the public switched telecommunications network (PSTN) 15. The local exchange delivers the Generic Number (GN) transparently to the destination subscriber unit 13. The protocol between the local exchange and the destination subscriber unit may be Direct Subscriber Signaling System No. 1 (DSS1) or another suitable protocol.

It will be appreciated that, while the preferred embodiment refers to the Generic Number GN128 being used for this purpose, the invention may be equally used with other appropriate GN values.

Table 2 below shows example code for sending an IP address of a service control point (SCP) to a MSC as specified by technical specification 3GPP TS 29.078, and illustrates how the generic number GN128 can be included in the CAP-CON or CAP-CWA operation commands.

TABLE 2
connect {PARAMETERS-BOUND : bound} OPERATION ::= {

| | |
|---|---|
| ARGUMENT | ConnectArg {bound} |
| RETURN RESULT | FALSE |
| ERRORS | {missingParameter \| |
| | parameterOutOfRange \| |
| | systemFailure \| |
| | taskRefused \| |
| | unexpectedComponentSequence \| |
| | unexpectedDataValue \| |
| | unexpectedParameter \| |
| | unknownLegID} |
| CODE | opcode-connect} |

ConnectArg {PARAMETERS-BOUND : bound} ::= SEQUENCE {

| destinationRoutingAddress | [0] DestinationRoutingAddress {bound}, | |
|---|---|---|
| alertingPattern | [1] AlertingPattern | OPTIONAL, |
| originalCalledPartyID | [6] OriginalCalledPartyID {bound} | OPTIONAL, |
| extensions | [10] Extensions {bound} | OPTIONAL, |
| carrier | [11] Carrier {bound} | OPTIONAL, |
| callingPartysCategory | [28] CallingPartysCategory | OPTIONAL, |
| redirectingPartyID | [29] RedirectingPartyID {bound} | OPTIONAL, |
| redirectionInformation | [30] RedirectionInformation | OPTIONAL, |
| genericNumbers | [14] GenericNumbers {bound} | OPTIONAL, |

serviceInteractionIndicatorsTwo [15] ServiceInteractionIndicatorsTwo

| | | |
|---|---|---|
| | | OPTIONAL, |
| chargeNumber | [19] ChargeNumber {bound} | OPTIONAL, |
| legToBeConnected | [21] LegID | OPTIONAL, |
| cug-Interlock | [31] CUG-Interlock | OPTIONAL, |
| cug-OutgoingAccess | [32] NULL | OPTIONAL, |
| suppressionOfAnnouncement | [55] SuppressionOfAnnouncement | OPTIONAL, |
| oCSIApplicable | [56] OCSIApplicable | OPTIONAL, |
| naOliInfo | [57] NAOliInfo | OPTIONAL, |
| bor-InterrogationRequested | [58] NULL | OPTIONAL, |
| ... | | |
| } | | |

GenericNumbers {PARAMETERS-BOUND : bound} ::= SET
SIZE(1..bound.&numOfGenericNumbers) OF GenericNumber {bound}

| | |
|---|---|
| NUM-OF-GENERIC-NUMBERS | &numOfGenericNumbers |
| NUM-OF-GENERIC-NUMBERS | 5 |

GenericNumber {PARAMETERS-BOUND : bound} ::= OCTET STRING (SIZE(
bound.&minGenericNumberLength .. bound.&maxGenericNumberLength))

The generic number GN128 is encoded to contain the IP address of the CAMEL service instance in the service control point (SCP) 9. For example, a range of IP addresses can be allocated to the service control point (SCP) 9, each relating to a particular service. This enables the service control point (SCP) 9 to assign an IP address to a CAMEL service instance. As will be discussed later, the IP addresses can be IPv4 or IPv6. The invention does not exclude the use of other IP address formats than Ipv4 or Ipv6, or the use of address encoding techniques other than IP. The receiver of the call connection, i.e. the designation subscriber unit 13, that receives the DSS1 Setup message and that generates the DSS1 Connect message, is adapted to include its own (P address in the respective message that is returned towards the calling subscriber, i.e. include its own IP address in the DSS1 Connect message. Preferably, the Generic Number GN[1000,0001] (“GN129”) is used for this purpose. This Generic Number (GN) is then passed back transparently through the public switched telecommunications network (PSTN) 15, towards the initiator of the call.

The initiating mobile switching center (MSC) 5 is the point where the public network starts. The mobile switching center (MSC) 5 receives the generic number GN129 in the ISUP ANM or in the ISUP CON. Upon receipt of this information, the mobile switching center (MSC) 5 includes this element in the answer notification to the service control point (SCP) 9.

Table 3 below shows example code for returning the IP address of a destination . subscriber unit by a MSC to a service control point SCP as specified by technical specification 3GPP TS 29.078 and enhanced by the present invention, and illustrates example code relating to how the Generic Number GN129, retrieved from ISUP ANM, may be reported to the service control point (SCP) 9.

TABLE 3
eventReportBCSM {PARAMETERS-BOUND : bound} OPERATION ::= {

| | |
|---|---|
| ARGUMENT | EventReportBCSMArg {bound} |
| RETURN RESULT | FALSE |
| ALWAYS RESPONDS | FALSE |
| CODE | opcode-eventReportBCSM} |

EventReportBCSMArg {PARAMETERS-BOUND : bound} ::= SEQUENCE {

| eventTypeBCSM | [0] EventTypeBCSM, | |
|---|---|---|
| eventSpecificInformationBCSM | [2] EventSpecificInformationBCSM {bound} OPTIONAL, | |
| legID | [3] ReceivingSideID | OPTIONAL, |
| miscCallInfo | [4] MiscCallInfo DEFAULT {messageType | |
| | | request}, |
| extensions | [5] Extensions {bound} | OPTIONAL, |
| ... | | |
| } | | |

EventTypeBCSM ::= ENUMERATED {

| | |
|---|---|
| collectedInfo | (2), |
| analyzedInformation | (3), |
| routeSelectFailure | (4), |

| | |
|---|---|
| oCalledPartyBusy | (5), |

| | |
|---|---|
| oNoAnswer | (6), |
| oAnswer | (7), |
| oMidCall | (8), |

< remainder of data type definition not shown >
EventSpecificInformationBCSM {PARAMETERS-BOUND : bound} ::= CHOICE {

| | |
|---|---|
| routeSelectFailureSpecificInfo | [2] SEQUENCE { |

| | | |
|---|---|---|
| failureCause | [0] Cause {bound} | OPTIONAL, |
| ... | | |
| }, | | |

| | |
|---|---|
| oCalledPartyBusySpecificInfo | [3] SEQUENCE { |

| | | |
|---|---|---|
| busyCause | [0] Cause {bound} | OPTIONAL, |
| ... | | |
| }, | | |

| | |
|---|---|
| oNoAnswerSpecificInfo | [4] SEQUENCE { |

```
        -- no specific info defined --
        ...
        },
```

| | |
|---|---|
| oAnswerSpecificInfo | [5] SEQUENCE { |

| | |
|---|---|
| destinationAddress | [50] CalledPartyNumber {bound} |

| | | OPTIONAL, |
|---|---|---|
| or-Call | [51] NULL | OPTIONAL, |
| forwardedCall | [52] NULL | OPTIONAL, |
| chargeIndicator | [53] ChargeIndicator | OPTIONAL, |
| ext-basicServiceCode | [54] Ext-BasicServiceCode | OPTIONAL, |
| ext-basicServiceCode2 | [55] Ext-BasicServiceCode | OPTIONAL, |
| ... | | |
| genericNumbers | [56] GenericNumbers {bound} | |
| | | OPTIONAL, |

```
        },
    < remainder of data type definition not shown >
```

It will be appreciated that, while the preferred embodiment refers to the Generic Number GN129 being used for identifying the IP address of the destination subscriber unit, the invention may be equally used with other appropriate GN values.

The end-result of this process is that the CAMEL service instance and the destination subscriber unit 13, i.e. the receiver of the call, have exchanged one another's IP address. The service control point (SCP) 9 and the destination subscriber unit 13 are then able to establish an IP-based communication directly with one another using the IP link 23 shown in FIG. 2, based on the IP address information exchanged during the call set up and the call connect procedures.

The communication between the CAMEL service and end-user may take the form of, for example, a hyper text transfer protocol (http) session or a Session Initiation Protocol (SIP) session.

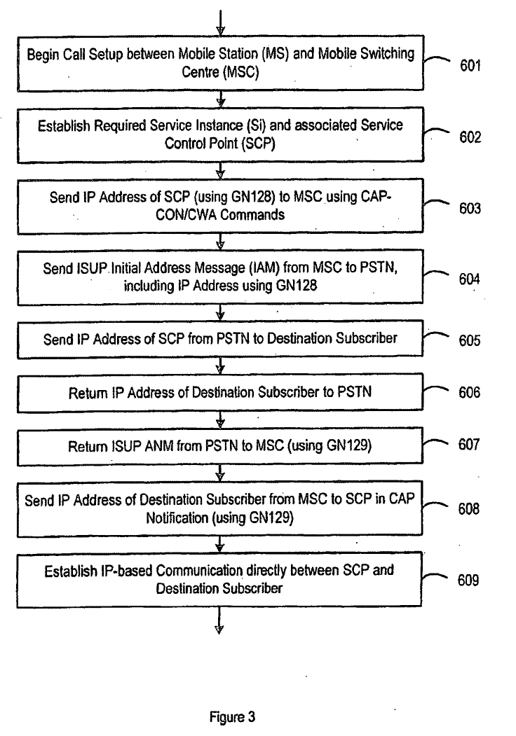

Referring to FIG. 3, a further description of the method of establishing an IP-based communication between the service control point (SCP) 9 and the destination subscriber unit 13 will now be made in conjunction with the telecommunications system shown in FIG. 2.

Following a call setup procedure initiated from a mobile station (MS) 3 to a mobile switching centre (MSC) 5, step 601, the required service instance (Si) is established, for example from a list of service instances (Sn) associated with a particular service control point (SCP) 9, step 602. The service instance may relate, for example, to an emergency call procedure. It is noted that communication between the mobile station (MS) 3 and the mobile switching center (MSC) 5 is effected using the direct transfer application part (DTAP) 7 of a mobile communication network.

The IP address relating to the service control point (SCP) 9 providing the service instance (Si) is then sent to the mobile switching center (MSC) 5, step 603, using the CAP operation command over the link 11 (for example using the CAP-CON or the CAP-CWA operation commands discussed earlier). Preferably, the generic number GN128 is used to transport the IP address during this call setup procedure.

The IP address, encoded in generic number GN128, is conveyed from the mobile switching center (MSC) 5 to the public switched telecommunications network (PSTN) 15 using the ISUP initial address message (ISUP IAM), step 604. The IP address is then passed from the public switched telecommunications network (PSTN) 15 to the destination subscriber unit 13, step 605.

The IP address of the destination subscriber unit 13 is then returned to the public switched telecommunications network (PSTN) 15, step 606.

In step 607, the IP address is passed from the public switched telecommunications network (PSTN) 15 to the mobile switching center (MSC) 5 using the ISUP answer message (ISUP ANM), preferably using the generic number GN129.

The IP address of the destination subscriber unit 13 is then sent from the mobile switching center (MSC) 5 to the service control point (SCP) 9 in a CAP notification, using the generic number GN129, step 608.

At this point the IP addresses of the service control point (SCP) 9 and the destination subscriber unit 13 have been exchanged. Communication directly between the service control point (SCP) 9 and the destination subscriber until 13 can then be established over the IP link 23. As discussed later in the application, the communication can either be established based on the initiation of the service control point (SCP) 9, or based on the initiation of the destination subscriber unit 13. It will be appreciated that, where only the IP address of the service control point (SCP) 9 is communicated to the destination subscriber unit 13, or vice versa, then the establishment of the IP-based communication link may be initiated by only the destination subscriber unit or the service control point, respectively.

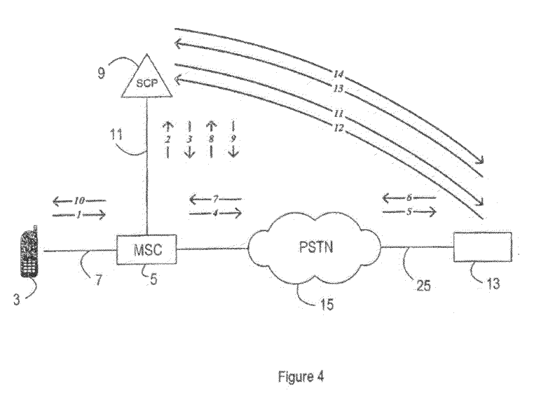

FIG. 4 shows in greater detail how the respective IP addresses are transported between the pubic switched telecommunications network (PSTN) 15 and the destination subscriber unit 13. A typical sequence for the establishment of an IP connection between the service control point (SCP) 9 and the destination subscriber unit 13 may be:
(1) calling party establishes a Mobile Originated (MO) call by sending DTAP Setup to the MSC
(2) MSC invokes a service logic instance in the SCP by sending CAP Initial DP to the SCP; the SCP now has control over the call
(3) the SCP sends CAP Connect to the MSC and includes its own IP Address in CAP Connect
(4) the MSC establishes the call to the PSTN by sending ISUP Initial Address Message (IAM) towards the PSTN and includes the IP address received from the SCP, in the ISUP IAM
(5) the PSTN offers the call to the destination subscriber unit by sending DSS1 Setup to the destination subscriber unit and includes the address received in ISUP IAM, in the DSS1 Setup
(6) the destination subscriber unit stores the IP address received from the PSTN and accepts the call by sending DSS1 Connect to the PSTN and includes its own IP address in the DSS1 Connect
(7) the PSTN sends an ISUP Answer Message (ANM) towards the MSC and includes the IP address received from the destination subscriber unit in the ISUP ANM
(8) the MSC notifies the SCP about the call answer and includes the IP address received in the ISUP ANM in the answer notification
(9) the SCP stores the IP address received from the MSC and instructs the MSC to propagate the ISUP ANM towards the calling subscriber
(10) the MSC notifies the calling subscriber about the answer event by sending DTAP Connect to the calling subscriber
(11) the SCP uses the IP address received in the answer notification to establish an IP-based communication session with the destination subscriber unit
(12) the destination subscriber unit accepts the IP-based communication session establishment

It is noted that Steps (11) and (12) may be replaced by:
(13) the destination subscriber unit uses the IP address received in the DSS1 Setup message to establish an IP-based communication session with the
(14) the SCP accepts the IP-based communication session establishment

Alternatively at step (7) the destination subscriber unit 13 sends a reply with its IP-address in the Address Complete Message (ACM) as defined in ISUP protocol, or “palert” message as defined in DSS1 protocol,

As discussed above, the Direct Transfer Application Part (DTAP) is used in the communication between the calling party and the mobile switching center (MSC) 5. The CAMEL Application Part (CAP) is used in the communication between the mobile switching center (MSC) 5 and the service control point (SCP) 9 over link 11, while Integrated Services User Part ISDN (ISUP) is used in the communication between the mobile switching center (MSC) 5 and the public switched telecommunications network (PSTN) 15.

Preferably, the IP address information is transported between the public switched telecommunications network (PSTN) 15 and the destination subscriber unit 13 using the Direct Subscriber Signaling System No. 1 (DSS1).

In order to make this possible, the DSS1 “Setup” message between the mobile switching center (MSC) 5 and the destination subscriber unit 13 is adapted to contain the generic number GN128. Preferably this involves adding GN128 to the list of information elements that may be included in the “Setup” message, as defined in ITU-T Q.931 (Digital subscriber Signaling System No. 1), section 3.1.14, table 3-15.

In addition, the DSS1 “Connect” message is adapted to contain the generic number GN129. Preferably this involves including GN129 to the list of information elements that may be included in the “Connect” message, as defined in ITU-T Q.931, section 3.1.4, table 3-5. More specifically, Q.951.3 (Description for Supplementary Services using DSS1) specifies additional elements for DSS1 Connect, such as Connected number and Connected sub-address, which may be adapted to include GN129.

As can be seen from the above, the invention enables the IP address of the service control point (SCP) 9 and the destination subscriber unit 13 to be exchanged by adapting existing communication protocols used for communicating in a telecommunication system.

When the CAMEL service has received the IP address of the destination subscriber unit 13, the service control point (SCP) 9 may initiate an IP-based communication session with that destination subscriber unit 13, using the direct communication link 23a. Alternatively, the destination subscriber unit 13 may initiate the IP-based communication with the service control point (SCP) 9, using the direct communication link 23b.

An additional safety mechanism may consist of providing a Challenge-Response method during the signaling procedure. For example, when the destination subscriber unit 13 reports its own IP address, the destination subscriber unit 13 is adapted to include a “Challenge” in the DSS1 Connect message 25. The challenge is a variable, for example a single OCTET, that is used by the service control point (SCP) 9 when contacting the destination subscriber unit 13. The destination subscriber unit 13 is adapted to verify that this Challenge was allocated to this Calling Party Number (i.e. allocated to that particular calling IP address), and if so permit the IP-based communication to be established. This prevents unauthorized access to the IP address that was reported by the destination subscriber unit 13 to the service control point (SCP) 9.

Preferably, the Challenge is transported from destination subscriber unit 13 to the service control point (SCP) 9 in the same manner as the Generic Number GN129. In other words, the Challenge is transported through the DSS1, ISUP and CAP protocols. The challenge may be transported in the same Generic Number (GN) as the IP address or may be transported in a designated Generic Number (GN).

In addition, or as an alternative to providing a Challenge in response to an IP-based communication initiated by the service control point (SCP) 9, a Challenge may also be included in the call establishment information flow for use with an IP-based communication initiated by the destination subscriber unit 13. In other words, the service control point (SCP) allocates a Challenge with the IP address information conveyed to the destination subscriber unit 13, and includes this Challenge in CAP CON/CWA.

The Challenge that is conveyed in the forward direction is adapted for use by the destination subscriber unit 13, when that destination subscriber unit 13 initiates the contact with the service control point (SCP) 9, i.e. starts the IP-based communication session. The destination subscriber unit 13 may include its Calling Party Number and the Challenge in the IP session set up. The service control point (SCP) 9 verifies that this Challenge is currently assigned to the indicated Calling Party Number or to the IP address of the destination subscriber unit 13.

As will be appreciated from the above, the provision of having a Challenge provides additional security during the establishment of an IP-based communication between the service control point (SCP) 9 and a destination subscriber unit 13.

Further reference will now be made to the encoding mechanism used for the Generic Numbers (GNs) adopted with the invention. As mentioned above, the IP addressing used with the invention may include IPv4 or IPv6 address formats.

An IPv4 address format consists of four Integer values in the range 0-255 (as defined by IETF Request For Comments (RFC) 791; IP v4). A generic number GN may contain two digits per octet; each digit may have a value in the range 0-9. An IPv4 address may have, for example, the following value:

255.255.64.48

If each digit is BCD encoded, then a total of 12 digits is needed to represent all possible IPv4 address; each field of an IPv4 address with a value below 100 is padded with leading 0('s). Since the maximum number of digits that a Generic Number (GN) may carry is at least 15 or 16, the Generic Number (GN) is able to represent any IPv4 address.

An IPv6 address consists of 128 bits (as defined by RFC 2460). Therefore, four Generic Numbers (GN) are needed to convey an Ipv6 address. Each Generic Number (GN) contains a part of the IPv6 address. In an embodiment of the present invention, GN130, G131, GN132 and GN133 may be used to transport the Ipv6 address of the service control point (SCP) 9 from the SCP to the local exchange in the public switched telecommunications network (PSTN) 15. And likewise, GN134, GN135, GN136 and GN137 may be used to transport the IPv6 address of the destination subscriber unit 13 from the local exchange in the public switched telecommunications network (PSTN) 15 to the service control point (SCP) 9.

It will be appreciated from the description of the preferred embodiments that the telecommunications system and method according to the invention provides an advantageous mechanism for establishing an IP-based communication directly between a service control point (SCP) 9 and a destination subscriber unit 13.

It can be seen that the CAMEL service that is controlling the call from a calling subscriber 3 includes the IP address of the service control point (SCP) 9 in the ISUP information flow and in the DSS1 information flow towards the destination subscriber unit 13.

The destination subscriber unit 13 (i.e. the connected party) in a call returns its IP address in the backwards signaling message in ISUP, towards the calling party 3.

The IP address of the destination subscriber unit 13 in the call is reported to the service control point (SCP) 9 of the calling party.

The exchange of IP addresses between the service control point (SCP) 9 and destination subscriber unit 13 facilitates TCP/IP based communication between the SCP 9 of the calling party 3 and the connected party 13, initiated either by the SCP 9 or the connected party 13.

Furthermore, the SCP 9 and destination subscriber unit 13 may exchange a Challenge. The Challenge is used during IP session establishment, for verification purposes.

It is noted that although the description of the preferred embodiment refers to various communication protocols such as CAP, ISUP and DSS1, it will be appreciated that one or more of these may be replaced by other communication protocols that can suitably transport the IP address of the respective parties.

Also, it will be appreciated that the term “mobile station” is intended to include any kind of mobile device that is arranged for setting up a mobile telephone call, including mobile telephones, laptop computers and personal digital assistants (PDAs).

Furthermore, the destination subscriber unit 13 is intended to embrace any form of terminal unit that is capable of establishing an IP-based communication session.

An advantage of having the service control point (SCP) 9 involved as explained above in setting up an IP-link towards a destination subscriber unit 13, is that the service control point (SCP) 9 is equipped to retrieve useful data for the destination subscriber unit by interrogating services residing within the service control point (SCP) 9 itself or elsewhere e.g. within an IP Multimedia Subsystem (IMS) domain. A calling party's terminal 3 would not able to retrieve said information in the way the SCP 9 performs for one of the reasons that the SCP 9 is regarded as a trusted network component whereas the terminal 3 is not.

Some examples of Information retrieved by the SCP 9 and forwarded to the destination subscriber unit 13 are:
Location information of the calling party's terminal 3 is retrieved by the SCP 9 from a mobility Platform service and communicated to the destination subscriber unit 13;
Subscriber related information of the calling party such as business card data, either retrieved from a service within the SCP or interrogated from a Home Location Register (HLR) is communicated to the destination subscriber unit 13;
Virtual Private Network (VPN) settings of the calling party, available in the SCP 9, are communicated to the destination subscriber unit 13;
Local Time zone data of the calling party is communicated to the destination subscriber unit 13.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. A method of establishing an IP-based communication link between a service control point of a calling subscriber and a destination subscriber unit, the method comprising the steps of:
communicating an IP address between the service control point 9 and the destination subscriber unit transferred by means of a circuit switched protocol via a circuit switched network communicatively connected to the service control point and the destination subscriber unit; and
establishing the IP based communication link between the service control point and the destination Subscriber unit based on the communicated IP address between the service control point and the destination subscriber unit.

2. The method as claimed in claim 1, wherein the IP address is communicated by means of a Generic Number (GN), a generic transport mechanism used in Integrated Services Digital Network User Part (ISUP) circuit switched protocol.

3. The method as claimed in claim 2, wherein the IP address is comprised in one or more generic number (GN) frame values reserved for national use, or spare generic number (GN) frame value.

4. The method as claimed in claim 1, wherein the IP address of the service control point is communicated to the destination subscriber unit.

5. The method as claimed in claim 1, wherein the IP address of the destination subscriber unit is communicated to the service control point.

6. The method as claimed in claim 1, wherein the IP address of the service control point is communicated to the destination subscriber unit, and the IP address of the destination subscriber unit is communicated to the service control point.

7. The method as claimed in claim 1, further comprising the step of performing a verification step prior to establishing the IP based communication link between the service control point and the destination subscriber unit.

8. The method as claimed in claim 7, wherein the verification step includes a challenge-response procedure.

9. The method as claimed in claim 8, wherein the challenge-response procedure involves providing password data by means of the generic number (GN) used for indicating the IP address.

10. The method as claimed in claim 8, wherein the challenge-response procedure involves providing password data by means of a generic number (GN) different from the generic number (GN) used for indicating the IP address.

11. The method as claimed in claim 9, wherein the challenge-response procedure is initiated by the service control point towards the destination subscriber unit.

12. The method as claimed in claim 9, wherein the challenge-response procedure is initiated by the destination subscriber unit towards the service control point.

13. The method as claimed in claim 12, wherein the challenge-response procedure involves providing password data in CAMEL Application Part (CAP) Connect (CON) or Continue with Argument (CWA) operation commands.

14. The method as claimed in claim 13, wherein the challenge-response procedure involves providing password data in a Digital Subscriber Signaling 1 (DSS1) Connect message.

15. The method as claimed in claim 2, wherein the IP address has a format as defined by Internet Engineering Task Force (IETF) such as Internet Protocol version 4 or version 6 (IPv4, IPv6), and wherein the IP address is encoded in one or more of the generic numbers (GN).

16. The method as claimed in claim 1, wherein establishment of the IP based communication link is initiated by the service control point.

17. The method as claimed in claim 1, wherein establishment of the IP-based communication link is initiated by the destination subscriber unit.

18. The method as claimed in claim 1, wherein the destination subscriber unit is a Circuit Switched (CS) terminal with an IP interface having one or more IP addresses.

19. The method as claimed in claim 1, wherein the service control point comprises an IP interface having one or more IP addresses, each IP address relating to a specific service provided by the service control point.

20. A telecommunications system for establishing an IP-based communication link g between a service control point of a calling subscriber and a destination subscriber unit, the telecommunications system comprising:
a circuit switched network for communicating an IP address transferred by means of a circuit switched protocol via the circuit switched network communicatively connected to the service control point and the destination subscriber unit; and
means for establishing the IP based communication link between the service control point and the destination subscriber unit based on the communicated IP address between the service control point and the destination subscriber unit.

21. The telecommunications system as claimed in claim 20, the circuit switched network comprising means for communicating the IP address by means of a generic number (GN) a generic transport mechanism used in Integrated Services Digital Network user part (ISUP) circuit switched protocol.

22. The telecommunications system as claimed in claim 21, wherein the IP address is comprised in one or more generic number (GN) frame values reserved for national use, or spare generic number (GN) frame value.

23. The telecommunications system as claimed in claim 20, wherein the IP address of the service control point is communicated by the service control point towards the destination subscriber unit

24. The telecommunications system as claimed in claim 20, wherein the IP address of the destination subscriber unit is communicated by the destination subscriber unit towards the service control point.

25. The telecommunications system as claimed in claim 20, further comprising means for performing a verification step prior to establishing the IP based communication link between the service control point and the destination subscriber unit.

26. The telecommunications system as claimed in claim 25, wherein the means for performing the verification step includes means for communicating a challenge between the service control point and the destination subscriber unit.

27. The telecommunications system as claimed in claim 26, wherein the challenge is initiated by the service control point towards the destination subscriber unit.

28. The telecommunications system as claimed in claim 27, wherein the challenge involves providing password data in CAMEL Application Part (CAP) Connect (CON) or Continue with Argument (CWA) operation commands.

29. The telecommunications system as claimed in claim 26, wherein the challenge is initiated by the destination subscriber unit towards the service control point.

30. The telecommunications system as claimed in claim 27, wherein the challenge involves providing password data in a Digital Subscriber Signaling 1 (DSS1) Connect message.

31. The telecommunications system as claimed in claim 21, wherein the IP address has a format as defined by Internet Engineering Task Force (IETF) such as Internet Protocol version 4 or version 6 (IPv4, IPv6), and wherein the IP address is encoded in one or more generic numbers (GN).

32. The telecommunications system as claimed in claim 20, wherein the service control point is adapted to initiate the establishment of the IP-based communication link.

33. The telecommunications system as claimed in claim 20, wherein the destination subscriber unit is adapted to initiate the establishment of the IP-based communication rink.

34. The telecommunications system as claimed in claim 20, wherein the destination subscriber unit is a Circuit Switched (CS) terminal with an IP interface having one or more IP addresses.

35. The telecommunications system as claimed in claim 20, wherein the service control point comprises an IP interface having one or more IP addresses, each IP address relating to a specific service provided by the service control point.

36-37. (canceled)
